(19) United States
(12) Patent Application Publication
(10) Pub. No.: US 2024/0357569 A1
(43) Pub. Date: Oct. 24, 2024

(54) Method for Mitigating Duplexing Issues in Sidelink Carrier Aggregation

(71) Applicant: Nokia Technologirs Oy, Espoo (FI)

(72) Inventors: Renato Barbosa Abreu, Aalborg (DK); Nuno Manuel Kiilerich Pratas, Gistrup (DK); Torsten Wildschek, Gloucester (GB); Laura Luque Sanchez, Nibe (DK); Thomas Haaning Jacobsen, Nørresundby (DK); Claude Arzelier, Molieres-sur-Ceze (FR); Takayuki Shimizu, Mountain View, CA (US); Berthold Panzner, Holzkirchen (DE); Kai-Erik Sunell, Antibes (FR)

(21) Appl. No.: 18/603,858

(22) Filed: Mar. 13, 2024

Related U.S. Application Data
(60) Provisional application No. 63/461,442, filed on Apr. 24, 2023.

(51) Int. Cl. H04W 72/0453; H04L 1/00; H04W 72/02; H04W 72/0446; H04W 72/51; H04W 72/566

(52) U.S. Cl. CPC H04W 72/0453; H04L 1/0068; H04W 72/02; H04W 72/0446; H04W 72/51; H04W 72/566

(57) ABSTRACT

An apparatus includes at least one processor; and at least one memory storing instructions that, when executed by the at least one processor, cause the apparatus at least to: determine whether the apparatus is expected to perform communication on a first carrier within a time interval, and communication on a second carrier within the time interval; determine whether there is a conflict between at least one symbol of the first carrier and at least one symbol of the second carrier within the time interval; determine at least one scheme to use for performing communication with at least one user equipment, when there is the conflict between the at least one symbol of the first carrier and the at least one symbol of the second carrier within the time interval; and perform the communication with the at least one user equipment using the at least one scheme.

### RELATED APPLICATION

This application claims priority to U.S. Provisional Application No. 63/461,442, filed Apr. 24, 2023, which is hereby incorporated by reference in its entirety.

### TECHNICAL FIELD

The examples and non-limiting example embodiments relate generally to communications and, more particularly, to a method for mitigating duplexing issues in sidelink carrier aggregation.

### BACKGROUND

It is known to facilitate communication between terminal devices in a communication network.

### SUMMARY

An apparatus includes at least one processor; and at least one memory storing instructions that, when executed by the at least one processor, cause the apparatus at least to: determine whether the apparatus is expected to perform communication on a first carrier within a time interval, and communication on a second carrier within the time interval; determine whether there is a conflict between at least one symbol of the first carrier and at least one symbol of the second carrier within the time interval; determine at least one scheme to use for performing communication with at least one user equipment, when there is the conflict between the at least one symbol of the first carrier and the at least one symbol of the second carrier within the time interval; and perform the communication with the at least one user equipment using the at least one scheme.

An apparatus includes at least one processor; and at least one memory storing instructions that, when executed by the at least one processor, cause the apparatus at least to: receive, from at least one user equipment, an indication that the at least one user equipment is using at least one scheme to perform communication with the apparatus, when there is the conflict between at least one symbol of a first carrier and at least one symbol of a second carrier within a time interval; and perform the communication with the at least one user equipment with use of the at least one scheme, when there is the conflict between at least one symbol of the first carrier and at least one symbol of the second carrier within the time interval.

An apparatus includes at least one processor; and at least one memory storing instructions that, when executed by the at least one processor, cause the apparatus at least to: serve a coverage area comprising at least one first user equipment and at least one second user equipment; receive a configuration from the at least one second user equipment; and transmit the configuration to the at least one first user equipment; wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows a resource selection procedure of 3GPP Rel-14/15 LTE-V2X PC5 mode 4.

FIG. 3 shows a resource candidate determination procedure of 3GPP Rel-14/15 LTE-V2X PC5 mode 4.

FIG. 4 shows a resource selection procedure of 3GPP Rel-16/17 5G NR-V2X PC5 mode 2.

FIG. 5 shows a resource candidate determination procedure of 3GPP Rel-16/17 5G NR-V2X PC5 mode 2.

FIG. 6 shows an example of a slot format of PSCCH, PSSCH, and PSFCH.

FIG. 7A is an illustration of a conflicting PSFCH reception in carrier CC-1 with a PSSCH transmission in carrier CC-2.

FIG. 7B is an illustration of a conflicting PSCCH/PSSCH reception in carrier CC-1 with a PSSCH transmission in carrier CC-2.

FIG. 8 shows an example of the herein described solution.

FIG. 9 is a signaling diagram of the herein described solution.

FIG. 10 is an example apparatus configured to implement the examples described herein.

FIG. 11 shows a representation of an example of non-volatile memory media used to store instructions that implement the examples described herein.

FIG. 12 is an example method, based on the examples described herein.

FIG. 13 is an example method, based on the examples described herein.

FIG. 14 is an example method, based on the examples described herein.

### DETAILED DESCRIPTION OF EXAMPLE EMBODIMENTS

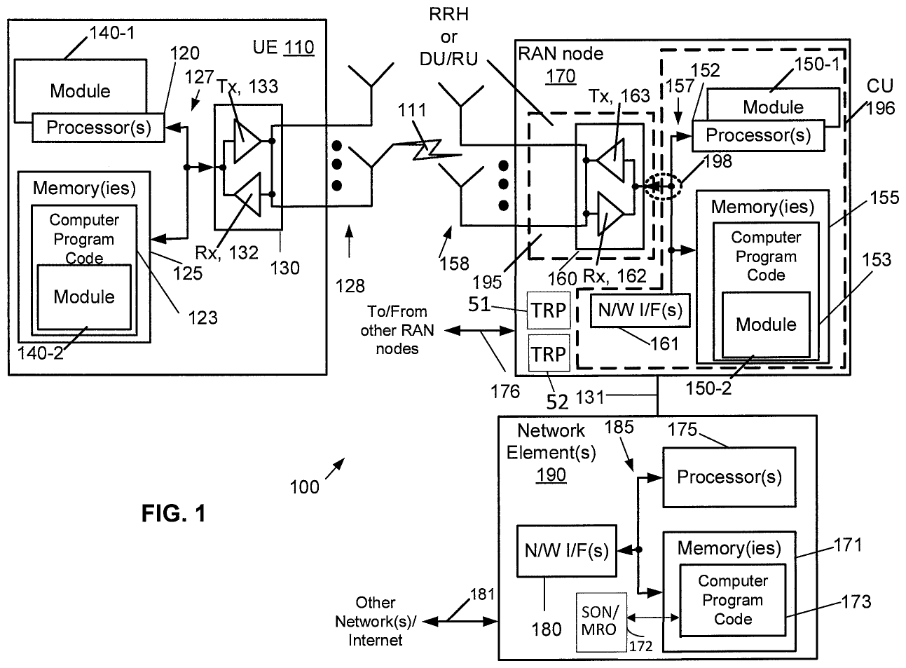

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including a method for mitigating duplexing issues in sidelink carrier aggregation. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The examples described herein relate to a method where a sidelink UE is configured for carrier aggregation and performs steps/signaling. In particular, the UE is configured to determine conflicting symbols in SL CA transmissions depending on its capability. This way the UE determines whether it should perform a transmission/reception of a channel on a first carrier and initiate also a transmission/reception interval on a second carrier. Related to this is the determination of if there is a conflict on the symbols where simultaneous transmission/reception occurs.

### Background Technologies

There are two main 3GPP sidelink technologies for vehicle-to-everything (V2X) direct communications: 3GPP Rel-14/15 LTE-V2X PC5 mode 4 and 3GPP Rel-16/17 5G NR-V2X PC5 mode 2.

### 1) Rel-14/15 LTE-V2X PC5 Mode 4:

Rel-14/15 LTE-V2X PC5 mode 4 employs discrete Fourier transform spread orthogonal frequency division multiplexing (DFT-s-OFDM) for sidelink at the PHY layer. Time-frequency radio resources are divided into subframes in the time domain and sub-channels in the frequency domain. LTE-V2X supports only 15-kHz sub-carrier spacing (SCS). Each subframe is 1-ms in length and consists of 14 DFT-s-OFDM symbols. Each sub-channel consists of multiple contiguous physical resource blocks (PRBs), where each PRB occupies 180 kHz and consists of 12 subcarriers with 15 kHz SCS, and the size of the sub-channel (i.e., the number of PRBs per sub-channel) is (pre-) configurable. To cope with high Doppler caused by high relative speed in vehicular scenarios, the density of demodulation reference signal (DMRS), which is used for frequency offset compensation and channel estimation, is set to four per subframe. Each user equipment (UE) broadcasts data (TB: transport block) in the physical sidelink shared channel (PSSCH) as well as sidelink control information (SCI) Format 1 in the physical sidelink control channel (PSCCH). PSCCH occupies two contiguous PRBs, whereas the number of PRBs for PSSCH is (pre-) configured. SCI Format 1 contains necessary information to decode its corresponding TB in PSSCH and facilitate UE autonomous resource selection. The resource reservation interval can be set to one of the allowed values (20, 50, 100, 200, 300, . . . , 1000 ms). PSCCH and the corresponding PSSCH need to be transmitted in the same subframe in either adjacent or non-adjacent PRBs in the frequency domain.

The resource selection procedure is specified in 3GPP TS 36.213 and TS 36.321.

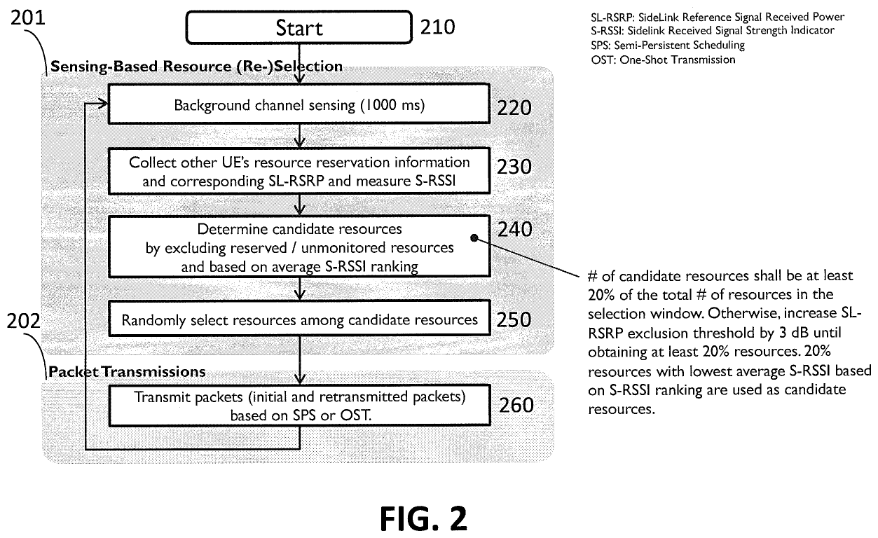

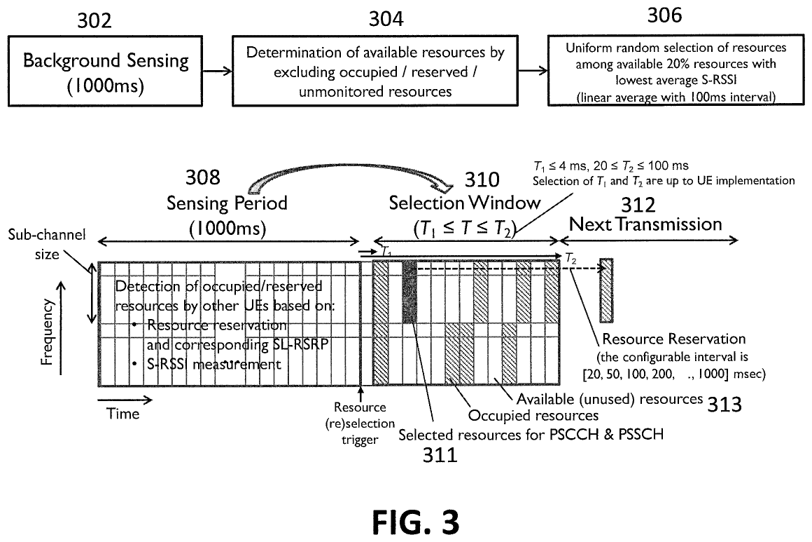

FIG. 2 depicts the flow chart of the resource selection procedure of 3GPP Rel-14/15 LTE-V2X PC5 mode 4, performed for example by UE 110. FIG. 3 depicts the resource candidate determination procedure of 3GPP Rel-14/15 LTE-V2X PC5 mode 4.

Referring to FIG. 2 (procedure starting at 210) and FIG. 3, for resource selection, a UE 110 performs channel sensing (220, 302) in the sensing window 308 (the last 1000 ms) to collect other UE's resource reservation information (230) based on SCI (sidelink control information) decoding to identify candidate resources (240, 304) in the selection window (T₁≤T≤T₂) 310, where T₁≤4 [ms] and 20≤T₂≤100 [ms]. First, the UE 110 excludes some subframes from the selection window due to unmonitored resources in the sensing window 308 that the UE 110 cannot sense due to its own transmission (i.e., half-duplex constraint). Then, the UE 110 further excludes resources reserved by other UEs from the selection window 310 if the corresponding SL-RSRP (sidelink reference signal received power) exceeds the (pre-) configured SL-RSRP exclusion threshold. After resource exclusion (240, 304), the number of candidate resources shall be at least 20% of the total number of resources in the selection window 310. Otherwise, UE 110 increases the SL-RSRP exclusion threshold by 3 dB until obtaining at least 20% resources. Then, the UE 110 calculates the corresponding S-RSSI (sidelink received signal strength indicator) of each sub-channel resource as a linear average over the S-RSSIs of the monitored resources with a certain interval (the averaging interval is 100 ms for a resource reservation interval of greater than or equal to 100 ms). The UE 110 determines the 20% best resources in terms of lowest average S-RSSI as the candidate resources among the total resources in the selection window. Finally, the UE 110 selects a single-subframe resource 311 in a uniformly random manner among candidate single-subframe resources (250, 306, 313). The selected frequency resource can be used multiple times with a fixed time interval for subsequent transmissions 260, 312 (this scheme is referred to as semi-persistent scheduling (SPS)) or only once 260 (this scheme is referred to as one-shot transmission (OST)). UE can retransmit 260, 312 a packet up to one time without feedback from receiver UEs to improve the reliability (this is called blind HARQ retransmission). The procedure shown in FIG. 2 includes sensing-based resource (re-) selection 201 which comprises items 220, 230, 240, and 250, and packet transmissions 202 which comprises item 260.

### LTE-V2X Carrier Aggregation:

Rel-15 LTE-V2X PC5 mode 4 supports sidelink carrier aggregation (SL CA). Multiple sidelink carriers (i.e., multiple V2X channels) can be used to increase the throughput and/or improve the reliability. To increase the throughput, multiple MAC PDUs can be transmitted on multiple sidelink carriers. To improve the reliability, PDCP duplication is supported, in which the same PDCP packet is transmitted on multiple sidelink carriers. 3GPP TS 36.321 Clause 5.14.1.5 specifies the Tx carrier (re-) selection procedure to (re-) select sidelink carriers for transmission based on the measured CBR for each sidelink carrier. In the Tx carrier (re-) selection procedure, the Tx UE considers sidelink carriers as candidate sidelink carriers if the measured CBR of the sidelink carrier is below a (pre-) configured CBR threshold (associated with priority). Then, Tx UE selects one or more sidelink carrier(s) among the candidate sidelink carriers with increasing order of CBR from the lowest CBR. It is left to UE implementation how many sidelink carriers Tx UE selects based on UE capability. For each selected sidelink carrier, LTE SL CA reuses the sensing and resource selection procedure in Rel-14 LTE-V2X PC5 mode 4 (i.e., UE selects resources independently on each involved carrier based on Rel-14 sensing and resource selection procedure. The Rel-14 resource selection procedure does, however, take into account the Tx UE capability on whether it can transmit on multiple carriers at a time or not, such that the resource procedure does not select resources for transmission that violate the Tx UE capabilities. The same sidelink carriers are used at least until the process triggers Tx carrier re-selection.

### 2) Rel-16/17 5G NR-V2X PC5 Mode 2:

Rel-16/17 5G NR-V2X PC5 mode 2 employs orthogonal frequency division multiplexing (OFDM) at the PHY layer. Time-frequency radio resources are divided into slots in the time domain and sub-channels in the frequency domain. NR-V2X supports SCSs of 15·2^{m} kHz, where m is the OFDM numerology m={0, 1, 2, 3, 4}. For sub-6 GHz frequency, SCSs of 15, 30, and 60 kHz (i.e., m={0, 1, 2}) are supported, whereas for above 6 GHZ frequency, SCSs of 60, 120, and 240 kHz (i.e., m={2, 3, 4}) are supported. Each slot is ½″ ms length and consists of 14 OFDM symbols. Each sub-channel consists of multiple contiguous physical resource blocks (PRBs), where each PRB occupies 180·2^{m} kHz and consists of 12 subcarriers with 15·2^{m} KHz SCS, and the size of sub-channel (i.e., the number of PRBs per sub-channel) is (pre-) configurable. To support multiple SCSs and different Doppler spreads, multiple DMRS density options (2˜4 DMRS symbols per slot) are supported. Each UE transmit 1^{st}-stage SCI (SCI format 1-A) in the PSCCH and data (TB: transport block) as well as 2^{nd}-stage SCI (SCI format 2-A or 2-B) in the PSSCH. HARQ feedback (ACK/NACK or NACK only) may be transmitted.

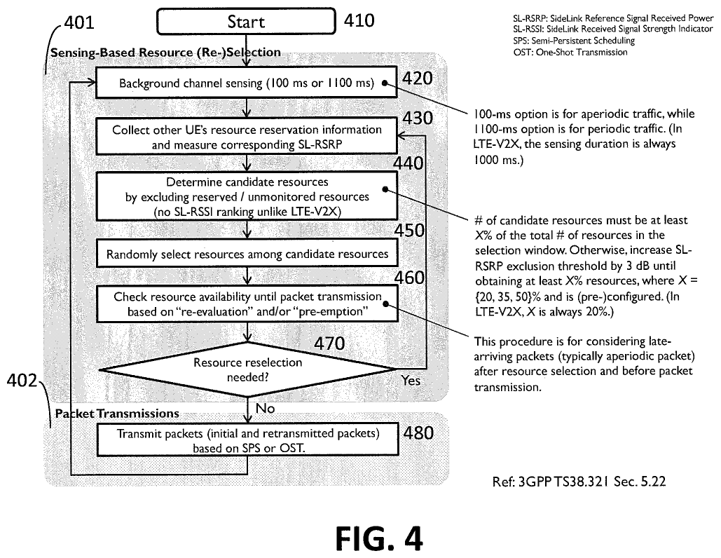

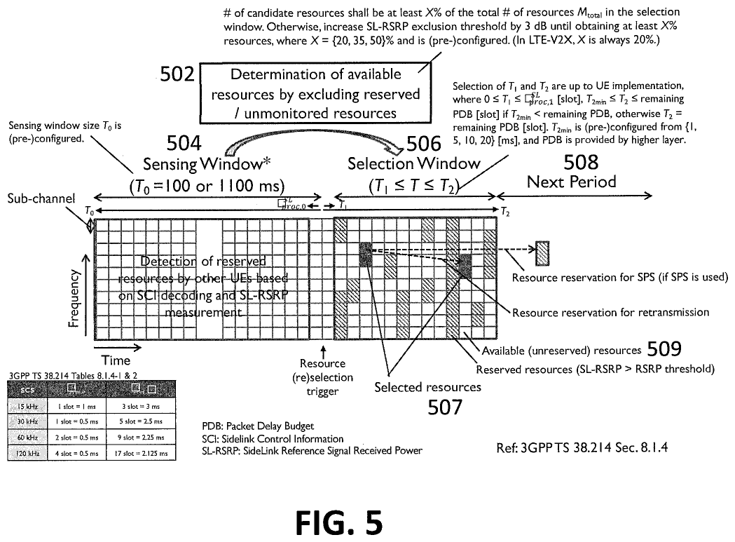

The resource selection procedure is specified in 3GPP 38.213, TS 38.214, and TS 38.321. FIG. 4 depicts the flowchart of the resource selection procedure of 3GPP Rel-16/17 5G NR-V2X PC5 mode 2. FIG. 5 depicts the resource candidate determination procedure of 3GPP Rel-16/17 5G NR-V2X PC5 mode 2.

Referring to FIG. 4 and FIG. 5, for resource selection (401, 502), UE 110 performs channel sensing 420 in the sensing window 504 and collects other UE's resource reservation information based on SCI (sidelink control information) 430 decoding to identify candidate resources (440) in the selection window (T₁≤T≤T₂) 506. First, the UE 110 excludes some time slots from the selection window 506 due to unmonitored resources in the sensing window that the UE 110 cannot sense due to its own transmission (i.e., half-duplex constraint). Then, the UE 110 further excludes resources reserved by other UEs from the selection window 506 if the corresponding SL-RSRP exceeds the (pre-) configured SL-RSRP exclusion threshold. After resource exclusion, the number of candidate resources (509) shall be at least X % of the total number of resources in the selection window 506. Otherwise, UE 110 increases the SL-RSRP exclusion threshold by 3 dB until obtaining at least X % resources, where X is (pre-) configured from {20, 35, 50} %. Finally, the UE 110 randomly selects resources (507) among candidate resources (450, 509) in the selection window 506. The selected frequency resource 507 can be used for multiple times with a fixed time interval for subsequent transmissions 480 (i.e., SPS) or only once (i.e., OST), at 402, 480. Also, UE 110 can retransmit packets multiple times (i.e., HARQ retransmissions) 480 with or without feedback from receiver UEs to improve the reliability.

As further shown in FIG. 4, at 460 the UE 110 checks resource availability until packet retransmission based on re-evaluation and/or preemption. The procedure at 460 is for considering late-arriving packets (typically an aperiodic packet) after resource selection and before packet transmission. At 470, the UE determines whether resource reselection is needed. If at 470 the UE 110 determines that resource reselection is needed (e.g. “Yes”) the method transitions to 430. If at 470 the UE 110 determines that resource reselection is not needed (e.g. “No”) the method transitions to 480. In FIG. 4, the procedure starts at 410, and FIG. 5 shows next period 508.

In order for a UE to perform sensing and obtain the necessary information to receive other UEs' packets, the UE needs to decode SCI first. In Rel-16, there are 1^{st}-stage SCI (SCI format 1-A) and 2^{nd}-stage SCI (SCI format 2-A or 2-B) as defined in 3GPP TS 38.212. 1^{st}-stage SCI carries resource reservation information for future transmissions, as well as information about resource allocation and MCS for PSSCH, DMRS pattern, 2^{nd}-stage SCI format, etc. 2^{nd}-stage SCI carries control information for HARQ procedures, source/destination IDs, necessary information for distance-based groupcast (UE's zone ID and communication range requirement), etc. Based on resource reservation contained in 1^{st}-stage SCI, each UE avoids using reserved time/frequency resources by other UEs for its resource (re-) selection.

In Rel-17 5G NR-V2X PC5 mode 2, inter-UE coordination (IUC) is introduced, in which a UE-A sends coordination information about resources to a UE-B, and then the UE-B utilizes that information for its resource (re-) selection. The following schemes of inter-UE coordination are supported (1-2 as follows):
1. IUC scheme 1: A UE-A can provide to another UE-B indications of resources that are preferred to be included in UE-B's (re-) selected resources, or preferred to be excluded. When given resources to include, UE-B may rely only on those resources, at least if it does not support sensing/resource exclusion, or may combine them with resources identified by its own sensing procedure, before making a final selection. The indication from UE-A to UE-B is sent in MAC CE and/or 2^{nd}-stage SCI.
2. IUC scheme 2: A UE-A can provide to another UE-B an indication that resources reserved for UE-B's transmission (which may or may not be to UE-A) will be, or could be, subject to collision with a transmission from another UE. Then, UE-B can re-select new resources to replace them. The indication from UE-A to UE-B is sent in PSFCH.

There is a one-to-one mapping between a PSSCH resource and a PSFCH resource. This allows a receiver and transmitter to determine which PSSCH resource (slot and sub-channel) the information in the PSFCH resource refers to. When more than one sub-channel are used in PSSCH, then multiple PSFCH resources are also used.

Rel-16/17 5G NR-V2X PC5 mode 2 does not support sidelink carrier aggregation.

### HARQ Feedback for Sidelink Communication

In Rel-16 (the work item “5G V2X with NR sidelink”), PSFCH for sidelink communication was specified to carry HARQ feedback over the sidelink (at the physical layer) from a UE which is an intended recipient of a PSSCH transmission (henceforth an Rx UE) to the UE which performed the transmission (henceforth a Tx UE).

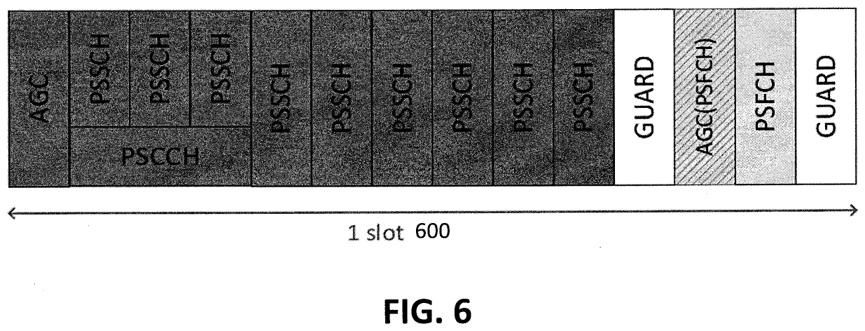

PSFCH transmits a Zadoff-Chu sequence in one PRB repeated over two OFDM symbols, the first of which can be used for AGC, near the end of the sidelink resource in a slot. An example of slot format of PSCCH, PSSCH, and PSFCH is provided in FIG. 6, which shows 1 slot 600. The Zadoff-Chu sequence as a base sequence is (pre-) configured per sidelink resource pool.

The time resources for PSFCH are (pre-) configured to occur once in every 1, 2, or 4 slots. HARQ feedback is disabled if periodicity is set to 0 (see SL-PSFCH-Config in TS 38.331). The HARQ feedback resource (PSFCH) is derived from the resource location of PSCCH/PSSCH.

For PSSCH-to-HARQ timing, the gNB 170 configures a parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources, for example, if the period of PSFCH resources is configured as 1, and K is configured as 2. For a PSSCH transmitted in slot 1, the time occasion for the corresponding PSFCH is slot 3.

In SL-CA it may happen that the PSFCH is configured differently for each of the carriers, e.g., with different periodicity (4 options are supported in current SL specification, as mentioning previously) or different subcarrier spacings over the different carriers (e.g., due to a legacy configuration in one of the carriers, or because one carrier coexists with LTE and uses 15 kHz and another carrier uses 30 kHz).

A half-duplexing issue may arise when mismatch occurs, depending on the UE capability related to transmitting and receiving simultaneously on different component carriers (CC) s, band combinations, and switching time. Receiving and transmitting simultaneously is particularly challenging when the frequency separation between CCs is low.

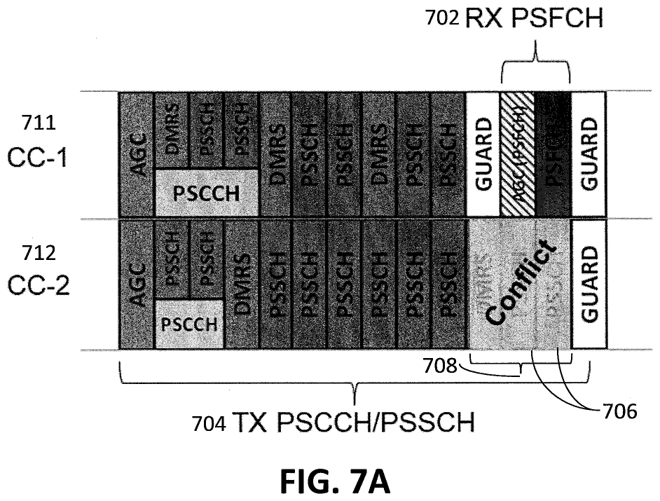

As an example, as shown in FIG. 7A, a UE 110 may not be capable to receive PSFCH (702) in one carrier (such as CC-1 711) while it transmits PSSCH (704, 706) in another carrier (such as CC-2 712), and vice-versa, resulting in conflict 708. Accordingly, FIG. 7A is an illustration of a conflicting PSFCH reception 702 in CC-1 711 with a PSSCH transmission 706 in carrier CC-2 712.

As another example, as shown in FIG. 7B, a UE 110 may not be capable to receive PSCCH/PSSCH (752) in one carrier (such as CC-1 761) while it transmits PSSCH (754, 756) in another carrier (such as CC-2 762), and vice-versa, resulting in conflict 758. Accordingly, FIG. 7B is an illustration of a conflicting PSCCH/PSSCH reception 752 in carrier CC-1 761 with a PSSCH transmission 756 in carrier CC-2 762. This may occur in case one carrier is configured for a higher subcarrier spacing (with corresponding shorter symbol and slot duration) such as CC-1 761 compared to another carrier of lower subcarrier spacing (with corresponding longer symbol and slot duration) such as CC-2 762.

Power control may also be affected if UE 110 needs to switch on in the other carrier in the middle of the slot, while transmitting in another carrier.

A trivial solution could be to only configure carriers with similar configuration. However that solution may not be always applicable, for example, in case there is a legacy deployment which cannot be changed in certain carriers.

Rel-14/15 LTE-V2X supports carrier aggregation, however it does not support PSFCH, and there is also a single subcarrier spacing supported, so the discussed issue is not covered in LTE. Rel-16/17 5G NR PC5 mode 2 does not support sidelink carrier aggregation, so the issue is not present and not covered in 5G NR sidelink either.

Described herein is a method for a SL UE configured for carrier aggregation, that includes the following (1-3):
1. The UE 110 determines whether it should perform a transmission/reception of a channel on a first carrier and initiate also a transmission/reception of another channel on a second carrier during the transmission/reception interval on the first carrier. The UE 110 may determine that it is expected to perform communication on the first carrier within a time interval, and communication on the second carrier within the time interval based on scheduling (e.g. in mode 1 resource allocation), or based on its resource selection decision (e.g. in mode 2), or based on a (pre) configured relation between transmission and feedback, or a (pre) configured resource allocation (e.g. for semi-persistent transmission, or periodic synchronization signal).
2. Based on that, in case the UE does not have capability to perform a simultaneous transmission/reception over the different carriers, the UE determines a conflict on the symbols where simultaneous transmission/reception occurs. Such symbols may be referred as conflicting symbols and might refer to a conflict experienced by the UE itself or an intended receiving UE.
3. Then the UE may apply one or more of the following schemes, depending on its capability and also on the capability of receiving UE(s) and timing (a-d):
a. A puncturing of the transmission over the conflicting symbols in at least one of the carriers. In this case there may be loss of coded bits as part of the transmission is removed. This option may be preferable when transmitting to a legacy UE. This option may also be applied in case the UE determines the need for PSFCH reception/transmission only after PSSCH transmission/reception on another carrier has already started.
b. A rate matching transmission over the resources around the conflicting symbols (preferable when conflicting symbols do not overlap PSCCH). This option may avoid loss of coded bits. The PSCCH may indicate for example the transmitting symbols and/or the modulation and coding rate applied. In some implementation, the UE may not resume a transmission/reception after the conflicting symbols in a slot, e.g., to avoid phase continuity issues.
c. A transmission in a subslot comprised by the symbol(s) before and/or after the conflicting symbols, the subslot being a configurable number of symbols, or one or more preconfigured/predefined subslot symbol(s). In some implementation, the RX UE may search PSCCH in slot and in sub-slot structure (possibly, or preferably, when conflicting symbols potentially overlap with PSCCH).
d. A cross-carrier prioritization for dropping the transmission/reception with lowest priority, e.g., skip PSFCH in one carrier if PSCCH/PSSCH on other carrier has higher priority, and vice-versa. Different prioritization rules may apply, e.g., based on associated traffic priority (e.g., from logical channel prioritization), transmission time (e.g., channel which starts first takes priority), carrier priority (e.g., channels on a certain CC have higher priority) and/or physical channel priority (e.g. PSFCH has higher priority than PSCCH/PSSCH), etc.

The UE 110 may decide if/when to apply one of the schemes depending, e.g., on capability, timing and priorities of the channels on the different carriers, and UE 110 may indicate if it applies the scheme (more details described herein). Alternatively or in addition, the one or more scheme(s) to apply may be decided by network configuration, e.g. via RRC configuration, or may be decided via pre-configuration in the terminal or USIM.

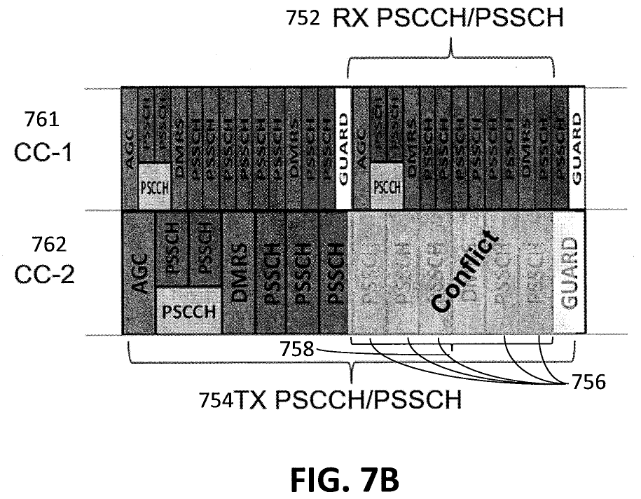

FIG. 8 illustrates an example of the solution, with e.g., (a) puncturing a transmission in CC2 during a reception in CC1 (810), (b) rate matching in which UE 110 encodes the information on CC2 assuming only the symbols not conflicting in time with a reception in CC1 (820), (c) sub-slot transmission in CC2 on the symbols prior to reception time in CC1 (830), (d) prioritization of transmission in CC2 assuming that channel in CC1 is for a lower priority traffic (840). This (including 840) is an example which should not restrict other scenarios, for example, where a UE 110 has to receive in CC2 and transmit in CC1.

Thus, as shown in FIG. 8, at 802 the UE 110 determines conflicting symbols considering its capability and/or pair UE(s) capability of tx/rx simultaneously on different CCs. At 804, the UE applies at least one of options (a) 810, (b) 820, (c) 830, or d (840), e.g. depending on capabilities, a supported scheme and/or pre-configuration. Option (a) 810 includes puncturing part of a transmission/reception, option (b) 820 includes transmitting or receiving a rate matched transmission, option (c) 830 includes transmitting or receiving on a subslot, e.g. prior to conflicting symbols, and option (d) 840 includes transmitting or receiving a channel of higher priority, e.g. in CC2, and skipping the other channel.

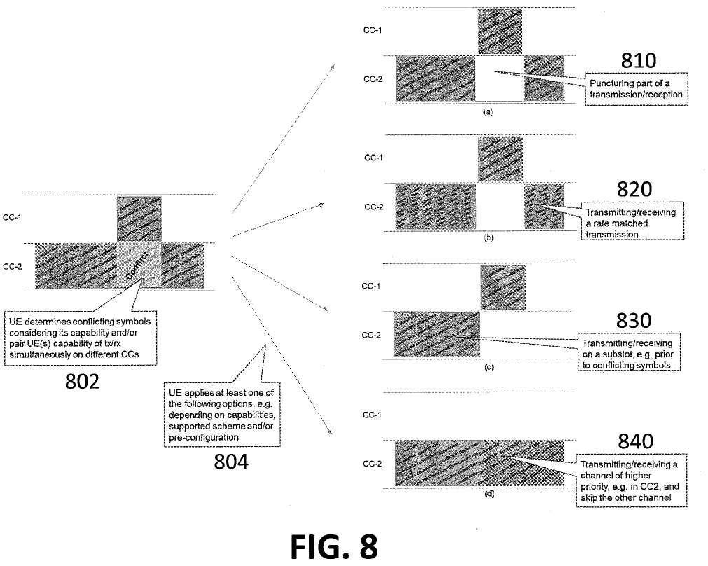

The solution may be implemented or specified including steps according to the flowchart depicted in FIG. 9. At 902, the UE1 110 and UE2 110-2 determine, receive, or transmit a configuration (e.g. via RRC) including capability of simultaneous transmission or reception between groups of carriers, switching time, scheme supported (puncturing, rate matching, subslot, and/or prioritization), and scheme configuration (e.g., subslot symbols). At 902, UE1 110 may receive the configuration from UE2 110, or the UE1 110 may transmit the configuration to UE2 110-2. Conversely, at 902 the UE1 110 may transmit the configuration to UE2 110-2, or the UE1 110 may receive the configuration from UE2 110-2.

Alternatively, the capability and scheme configuration can be exchanged through the network (e.g. through a gNB, access point, or base station such as RAN node 170).

At 904, UE1 110 determines conflicting symbols, based on reserved PSCCH/PSFCH resources, and expected PSFCH reception/transmissions. At 906, UE1 110 prepares PSCCH/PSFCH transmission applying puncturing, rate matching and/or a subslot scheme. At 908, UE1 110 transmits to UE2 110-2 whether UE1 110 is applying puncturing, rate matching or a subslot scheme (e.g., via PSCCH) for a channel in a certain carrier. At 910, UE1 110-1 transmits PSCCH or PSFCH to UE2 110-2 based on the applied scheme.

FIG. 9 illustrates one example, for example UE1 110 may not provide the indication of whether it is applying puncturing, rate matching and/or a subslot scheme for a channel in a certain carrier, e.g., in case the applied scheme is preconfigured or predetermined.

Accordingly, the examples described herein include communication between a user equipment and another user equipment configured for carrier aggregation, and the communication of the another user equipment with the user equipment comprises transmission or reception over a channel of the first carrier and transmission or reception over a channel of the second carrier, wherein the channel of the first carrier and the channel of the second carrier comprises a physical sidelink control channel, a physical sidelink shared channel, a physical sidelink feedback channel, or a sidelink synchronization signal block. The sidelink synchronization signal block (S-SSB) may carry a physical sidelink broadcast channel (PSBCH) as well as a sidelink primary synchronization signal (S-PSS) and a sidelink secondary synchronization signal (S-SSS).

In an embodiment, the SL UEs indicate capability related to simultaneous reception/transmission between sets of carriers, e.g., via RRC signaling, via MAC signaling, during capability transfer, during RRC connection setup as a part of a RRC connection setup complete message, or as part of UE assistance information, or during RP configuration. The capability can also be mandatory for a certain version or release of the standard, or associated with another capability e.g., with SL CA capability or defined as a default or fallback capability.

The UE may indicate whether it can transmit in a channel (e.g., PSFCH) and receive in another channel (e.g. PSSCH) simultaneously between groups of carriers. In some cases, the UE may be capable of such between one group of carriers (e.g. which are far separated in frequency), while it is not capable of such between another group of carriers (e.g., which are close to each other in frequency, or which are operated under a same front-end component on the UE).

The UE may also indicate whether it has the capability of initiating a transmission (e.g., PSFCH) in a carrier during an ongoing transmission (e.g. PSSCH) in another carrier. Instead or in addition, the UE may also indicate if it can initiate a reception in a carrier during an ongoing reception in another carrier.

The UE may also indicate the switch time between transmission and reception, and/or indicate whether it supports a predefined switch time requirement.

The UE may also indicate capability related to whether it supports transmitting/receiving rate matched transmission, and/or receiving transmission in a subslot. Not indicating this capability may imply the UE is a legacy UE which does not support the scheme.

In one embodiment, a UE may detect the capability of an RX UE and applies the corresponding scheme. E.g., if RX UE is not capable of decoding rate matched or subslot transmission, the TX UE applies puncturing. In this case, the TX UE may apply a lower MCS in order to increase the chance of successful reception of the slot with punctured symbol(s).

In another embodiment, the UE may decide whether to apply the scheme depending on the priority of the channels to be transmitted/received over the different carriers. In some cases, if priority of one channel is higher, or much higher, than the other (e.g., the priority difference is higher than a certain threshold), the UE may completely skip transmitting/receiving one or more of the channel(s) which is/are leading to conflict among another carrier, or different carriers.

In another embodiment, the UE may decide whether to apply the scheme depending on the timing occasion where conflicting symbol(s) occur (recall, a conflicting symbol refers to a symbol time duration where the UE expects to receive and transmit on different carriers simultaneously but does not have the capability to do so). In some cases, if conflicting symbol(s) occur in the beginning of the slot, e.g., overlapping with PSCCH and the RX UE does not have capability to decode in subslot after conflicting symbols, the TX UE may skip one or more of the channels (it may be predefined which channel it should skip, or if the priorities are different, the TX UE skips the one with lowest priority).

In another embodiment, the occasions where guard symbols on one carrier overlap with non-guard symbols in another carrier may also be considered conflicting symbols, depending e.g., on switching time. If switching time is long and the UE has to switch between transmission and reception over the different carriers, the guard symbols may also be punctured, and/or not used in rate-matching and/or subslot tx/rx.

In another embodiment, if the TX and/or the RX UEs do not support the transmission scheme, the UEs determine based on configuration or a pre-defined rule to not use the slots where the conflict occurs. E.g., the slots where the conflict occurs are excluded from the candidate resource set.

In another embodiment, if the TX UE does not comprehend the RX UE's indicated capabilities, e.g., due to future extensions, the UEs may make use of a pre-defined fallback or default transmission scheme.

In another embodiment, the TX UE and/or RX may change their capabilities by adding or removing capabilities in a reconfiguration message or upon capability enquiry to change the transmission scheme e.g., depending on the outcome of previous transmission occasions.

In another embodiment, the TX UE and/or RX UE may decide whether or not to apply the scheme(s) depending on the target destination of their transmissions when conflicting symbols occur. For example, even when conflicting symbols occur (e.g., PSCCH/PSSCH transmission by the TX UE on one carrier and PSFCH transmission by the RX UE on another carrier), if the RX UE is not a target UE of PSCCH/PSSCH transmission by the TX UE, the TX UE does not apply the scheme. Similarly, instead or in addition, if the TX UE is not a target UE of PSFCH transmission by the RX UE, the RX UE does not apply the scheme.

In another embodiment, the TX UE and/or RX UE may decide whether or not to apply one or more scheme(s) based on measurements related to the other UE, e.g. RSRP, RSSI, energy level. For example, the scheme(s) could be performed by the TX UE and/or RX UE only if the measured RSRP, RSSI, and/or energy level from the other UE exceeds one or more threshold(s), or is below one or more threshold(s).

In another embodiment, the TX UE and/or RX UE may decide whether or not to apply one or more scheme(s) based on the distance between the two UEs, for example by making use of geographical positioning information. In one embodiment, the scheme(s) may be performed by the RX UE and/or TX UE only if the distance is lower than a threshold, or only if the distance is higher than a threshold.

There are several advantages and technical effects of the herein described solution. The solution provides means for a UE to handle conflicting situations (e.g. due to half-duplexing) when communicating using multiple carriers. Without use of at least one of the herein described schemes, there may be ambiguity as pairs of transmitter and receiver UEs may not have a common way to overcome the issue in case at least one of the involved UEs is not capable of transmitting/receiving multiple channels simultaneously in different carriers.

The herein described solution may have specification impact on 3GPP specification, and may be part of the SL CA work item in Rel-18.

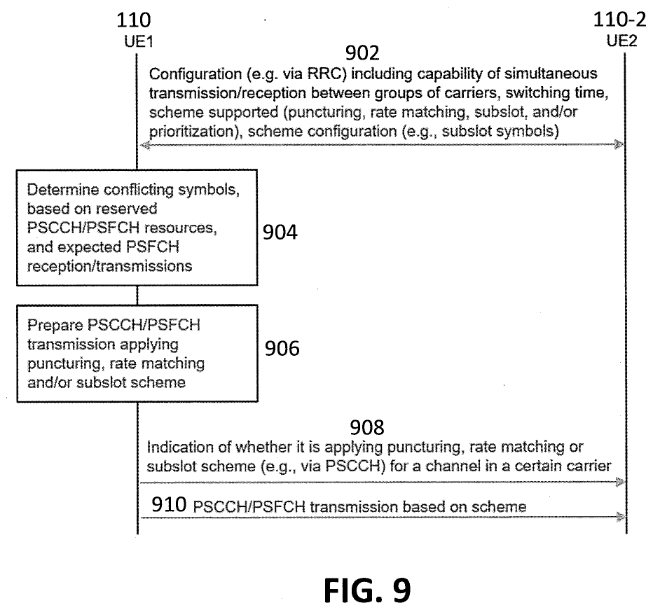

FIG. 10 is an example apparatus 1000, which may be implemented in hardware, configured to implement the examples described herein. The apparatus 1000 comprises at least one processor 1002 (e.g. an FPGA and/or CPU), one or more memories 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein, including a method for mitigating duplexing issues in sidelink carrier aggregation. The memory 1004 may be a non-transitory memory, a transitory memory, a volatile memory (e.g. RAM), or a non-volatile memory (e.g. ROM).

Scheme(s) 1030 of the control module 1006 implements performance of the herein described schemes. Scheme(s) indication 1040 may facilitate transmitting, to at least one user equipment (e.g. UE 110), an indication that the apparatus 1000 is using the at least one scheme to perform the communication with the at least one user equipment, when there is the conflict between the at least one symbol of a first carrier and the at least one symbol of a second carrier within a time interval. Scheme(s) indication 1040 may facilitate receiving, from at least one user equipment (e.g. UE 110) or the network (e.g. RAN node 170 or network element(s) 190), an indication that the at least one user equipment is using at least one scheme to perform communication with the apparatus 1000, when there is the conflict between at least one symbol of a first carrier and at least one symbol of a second carrier within a time interval.

The apparatus 1000 includes a display and/or I/O interface 1008, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1010. The communication I/F(s) 1010 may be wired and/or wireless and communicate over the Internet/other network(s) via any communication technique including via one or more links 1024. The link(s) 1024 may be the link(s) 131 and/or 176 from FIG. 1. The link(s) 131 and/or 176 from FIG. 1 may also be implemented using transceiver(s) 1016 and corresponding wireless link(s) 1026. The communication I/F(s) 1010 may comprise one or more transmitters or one or more receivers.

The transceiver 1016 comprises one or more transmitters 1018 and one or more receivers 1020. The transceiver 1016 and/or communication I/F(s) 1010 may comprise standard well-known components such as an amplifier, filter, frequency-converter, (de) modulator, and encoder/decoder circuitries and one or more antennas, such as antennas 1014 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the one or more processors 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the one or more processors 1002. For instance, the one or more memories 1004 store instructions that, when executed by the one or more processors 1002, cause the apparatus 1000 to perform one or more of the operations as described herein. Furthermore, the one or more processors 1002, one or more memories 1004, and example algorithms (e.g., as flowcharts and/or signaling diagrams), encoded as instructions, programs, or code, are means for causing performance of the operations described herein.

The apparatus 1000 to implement the functionality of control 1006 may be UE 110, RAN node 170 (e.g. gNB), or network element(s) 190. Thus, processor 1002 may correspond to processor(s) 120, processor(s) 152 and/or processor(s) 175, memory 1004 may correspond to one or more memories 125, one or more memories 155 and/or one or more memories 171, computer program code 1005 may correspond to computer program code 123, computer program code 153, and/or computer program code 173, control module 1006 may correspond to module 140-1, module 140-2, module 150-1, and/or module 150-2, and communication I/F(s) 1010 and/or transceiver 1016 may correspond to transceiver 130, antenna(s) 128, transceiver 160, antenna(s) 158, N/W I/F(s) 161, and/or N/W I/F(s) 180. Alternatively, apparatus 1000 and its elements may not correspond to either of UE 110, RAN node 170, or network element(s) 190 and their respective elements, as apparatus 1000 may be part of a self-organizing/optimizing network (SON) node or other node, such as a node in a cloud. Apparatus 1000 may also correspond to UE2 110-2.

The apparatus 1000 may also be distributed throughout the network (e.g. 100) including within and between apparatus 1000 and any network element (such as a network control element (NCE) 190 and/or the RAN node 170 and/or the UE 110).

Interface 1012 enables data communication and signaling between the various items of apparatus 1000, as shown in FIG. 10. For example, the interface 1012 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control 1006 may comprise object-oriented software configured to pass data or messages between objects within computer program code 1005. The apparatus 1000 need not comprise each of the features mentioned, or may comprise other features as well. The various components of apparatus 1000 may at least partially reside in a common housing 1028, or a subset of the various components of apparatus 1000 may at least partially be located in different housings, which different housings may include housing 1028.

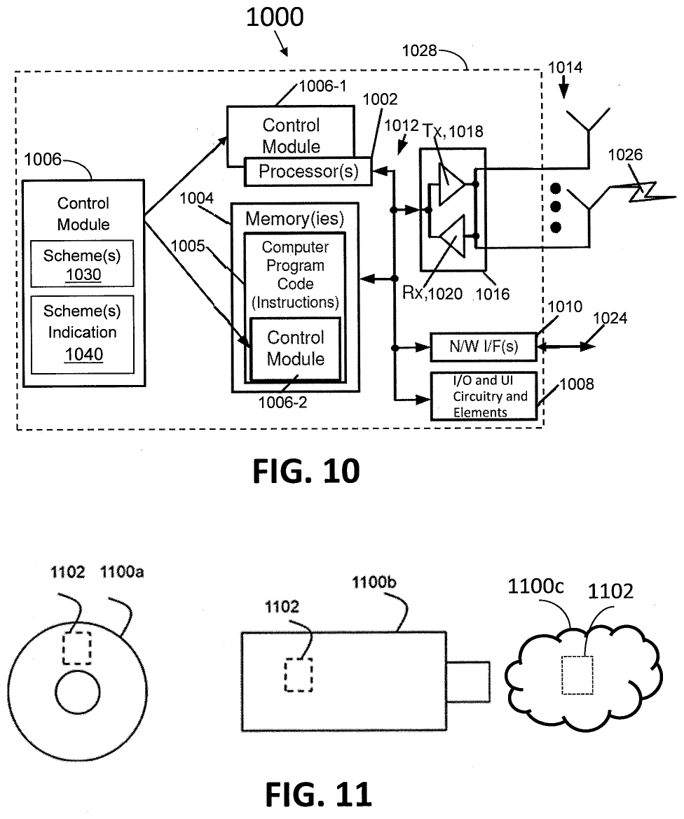

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage) storing instructions and/or parameters 1102 which when executed by a processor allows the processor to perform one or more of the steps of the methods described herein.

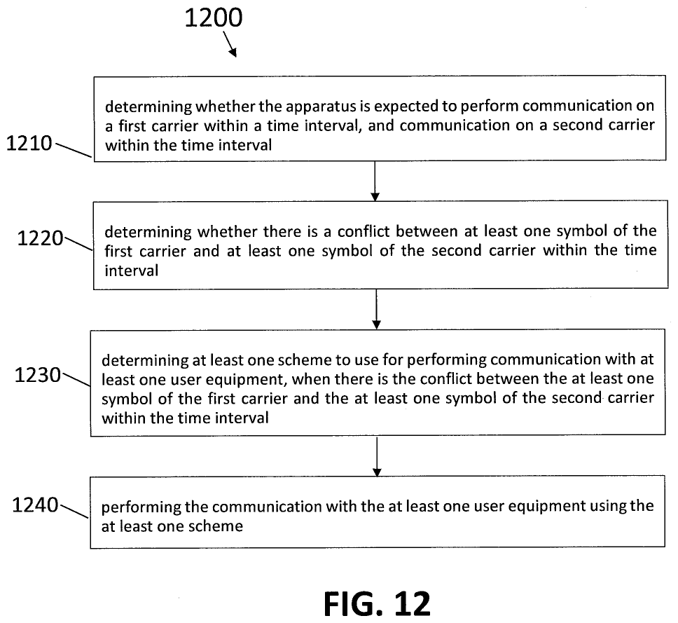

FIG. 12 is an example method 1200, based on the example embodiments described herein. At 1210, the method includes determining whether the apparatus is expected to perform communication on a first carrier within a time interval, and communication on a second carrier within the time interval. At 1220, the method includes determining whether there is a conflict between at least one symbol of the first carrier and at least one symbol of the second carrier within the time interval. At 1230, the method includes determining at least one scheme to use for performing communication with at least one user equipment, when there is the conflict between the at least one symbol of the first carrier and the at least one symbol of the second carrier within the time interval. At 1240, the method includes performing the communication with the at least one user equipment using the at least one scheme. Method 1200 may be performed with a UE 110 or apparatus 1000.

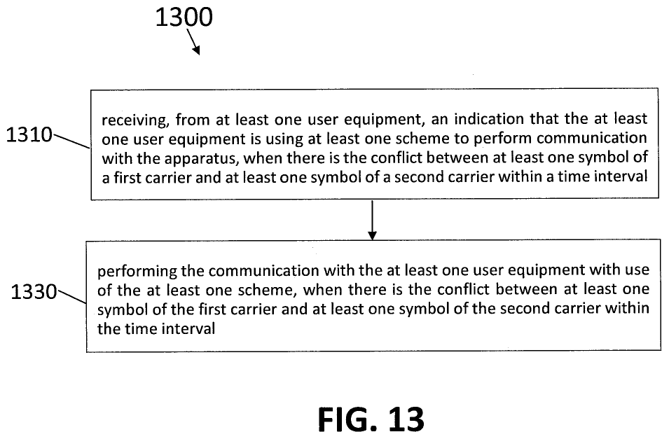

FIG. 13 is an example method 1300, based on the example embodiments described herein. At 1310, the method includes receiving, from at least one user equipment, an indication that the at least one user equipment is using at least one scheme to perform communication with the apparatus, when there is the conflict between at least one symbol of a first carrier and at least one symbol of a second carrier within a time interval. At 1320, the method includes performing the communication with the at least one user equipment with use of the at least one scheme, when there is the conflict between at least one symbol of the first carrier and at least one symbol of the second carrier within the time interval. Method 1300 may be performed with UE 110-2 (which has a similar technical configuration as UE 110 as shown in FIG. 1) or apparatus 1000.

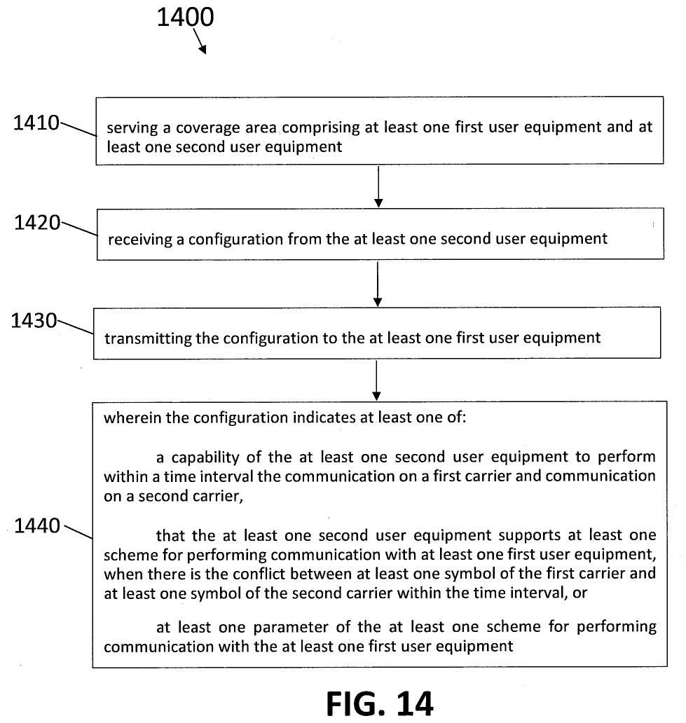

FIG. 14 is an example method 1400, based on the example embodiments described herein. At 1410, the method includes serving a coverage area comprising at least one first user equipment and at least one second user equipment. At 1420, the method includes receiving a configuration from the at least one second user equipment. At 1430, the method includes transmitting the configuration to the at least one first user equipment. At 1440, the method includes wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment. Method 1400 may be performed with a network node such as RAN node 170 or apparatus 1000.

The following examples are provided and described herein.
Example 1. An apparatus including: at least one processor; and at least one memory storing instructions that, when executed by the at least one processor, cause the apparatus at least to: determine whether the apparatus is expected to perform communication on a first carrier within a time interval, and communication on a second carrier within the time interval; determine whether there is a conflict between at least one symbol of the first carrier and at least one symbol of the second carrier within the time interval; determine at least one scheme to use for performing communication with at least one user equipment, when there is the conflict between the at least one symbol of the first carrier and the at least one symbol of the second carrier within the time interval; and perform the communication with the at least one user equipment using the at least one scheme.
Example 2. The apparatus of example 1, wherein the instructions, when executed by the at least one processor, cause the apparatus at least to: determine that the apparatus is expected to perform the communication on the first carrier within the time interval, and the communication on the second carrier within the time interval based on at least one of scheduling, a resource selection decision, a configured relation between transmission and feedback, or a configured resource allocation. Thus, the UE 110 may determine that the UE 110 is expected to perform communication on a first carrier within a time interval, and communication on a second carrier within the time interval based on scheduling (e.g. in mode 1 resource allocation), or based on its resource selection decision (e.g. in mode 2), or based on a (pre) configured relation between transmission and feedback, or a (pre) configured resource allocation (e.g. for semi-persistent transmission, or periodic synchronization signal).
Example 3. The apparatus of any of examples 1 to 2, wherein the instructions, when executed by the at least one processor, cause the apparatus at least to: transmit, to the at least one user equipment, an indication that the apparatus is using the at least one scheme to perform the communication with the at least one user equipment, when there is the conflict between the at least one symbol of the first carrier and the at least one symbol of the second carrier within the time interval.
Example 4. The apparatus of any of examples 1 to 3, wherein the instructions, when executed by the at least one processor, cause the apparatus at least to: receive a configuration from the at least one user equipment or from a network. Thus, the capability and scheme configuration can be exchanged through the network (e.g. through a gNB, access point, or base station).
Example 5. The apparatus of example 4, wherein the configuration indicates a capability of the at least one user equipment to perform within the time interval the communication on the first carrier and the communication on the second carrier
Example 6. The apparatus of any of examples 4 to 5, wherein the configuration indicates that the at least one user equipment supports the at least one scheme.
Example 7. The apparatus of any of examples 4 to 6, wherein the configuration indicates at least one parameter of the at least one scheme.
Example 8. The apparatus of example 7, wherein the at least one parameter comprises at least one subslot symbol.
Example 9. The apparatus of any of examples 1 to 8, wherein the instructions, when executed by the at least one processor, cause the apparatus at least to: transmit a configuration to the at least one user equipment.
Example 10. The apparatus of example 9, wherein the configuration indicates a capability of the apparatus to perform within the time interval the communication on the first carrier and the communication on the second carrier.
Example 11. The apparatus of any of examples 9 to 10, wherein the configuration indicates that the apparatus supports the at least one scheme.
Example 12. The apparatus of any of examples 1 to 11, wherein the apparatus comprises another user equipment configured for carrier aggregation, and the communication with the at least one user equipment comprises transmission or reception over a channel of the first carrier and transmission or reception over a channel of the second carrier, wherein the channel of the first carrier and the channel of the second carrier comprises a physical sidelink control channel, a physical sidelink shared channel, a physical sidelink feedback channel, or a sidelink synchronization signal block. The sidelink synchronization signal block (S-SSB) may carry a physical sidelink broadcast channel (PSBCH) as well as sidelink primary synchronization signal (S-PSS) and sidelink secondary synchronization signal (S-SSS).
Example 13. The apparatus of any of examples 1 to 12, wherein the instructions, when executed by the at least one processor, cause the apparatus to determine the at least one scheme based on at least one of: a capability of the apparatus, a capability of the at least one user equipment, a timing of a channel of the first carrier and a timing of a channel of the second carrier, a switch time between communication over the first carrier and the second carrier, a priority of the first carrier and a priority of the second carrier, a target destination of the communication, the target destination comprising the apparatus or the at least one user equipment, at least one measurement related to the at least one user equipment, a distance between the apparatus and the at least one user equipment being lower or higher than a threshold, a network configuration, or a configuration of the apparatus.
Example 14. The apparatus of any of examples 1 to 13, wherein the at least one scheme comprises a puncturing of the communication over the at least one symbol of the first carrier that conflicts with the at least one symbol of the second carrier, or a puncturing of the communication over the at least one symbol of the second carrier that conflicts with the at least one symbol of the first carrier.
Example 15. The apparatus of example 14, wherein the at least one scheme comprises the puncturing of the communication when the at least one user equipment comprises a legacy user equipment.
Example 16. The apparatus of any of examples 14 to 15, wherein the at least one scheme comprises the puncturing of the communication when the apparatus determines to communicate over a physical sidelink feedback channel of one of the first carrier or the second carrier after a communication over a physical sidelink shared channel of another one of the first carrier or the second carrier has started.
Example 17. The apparatus of any of examples 1 to 16, wherein the at least one scheme comprises a rate matching comprising an encoding of information of at least one symbol of the first carrier that does not conflict with at least one symbol of the second carrier, or an encoding of information of at least one symbol of the second carrier that does not conflict with at least one symbol of the first carrier.
Example 18. The apparatus of example 17, wherein the at least one scheme comprises the rate matching when the conflict between the at least one symbol of the first carrier and the at least one symbol of the second carrier does not overlap with a physical sidelink control channel.
Example 19. The apparatus of any of examples 1 to 18, wherein the at least one scheme comprises a subslot communication on at least one symbol of the first carrier that does not conflict with at least one symbol of the second carrier, or a subslot communication on at least one symbol of the second carrier that does not conflict with at least one symbol of the first carrier.
Example 20. The apparatus of example 19, wherein the at least one scheme comprises the subslot communication when the conflict between the at least one symbol of the first carrier and the at least one symbol of the second carrier overlaps with a physical sidelink control channel.
Example 21. The apparatus of any of examples 1 to 20, wherein the at least one scheme comprises carrier prioritization comprising: the communication over the at least one symbol of the first carrier that conflicts with the at least one symbol of the second carrier without the communication over the at least one symbol of the second carrier that conflicts with the at least one symbol of the first carrier, when a priority associated with the first carrier is higher than a priority associated with the second carrier, or the communication over the at least one symbol of the second carrier that conflicts with the at least one symbol of the first carrier without the communication over the at least one symbol of the first carrier that conflicts with the at least one symbol of the second carrier, when the priority associated with the second carrier is higher than the priority associated with the first carrier.
Example 22. The apparatus of example 21, wherein the priority associated with the first carrier and the priority associated with the second carrier is based on at least one of: a physical sidelink feedback channel priority, a physical sidelink control channel priority, a physical sidelink shared channel priority, a sidelink synchronization signal block priority, a communication time associated with the first carrier and a communication time associated with the second carrier, or a priority of the first carrier and a priority of the second carrier.
Example 23. An apparatus including: at least one processor; and at least one memory storing instructions that, when executed by the at least one processor, cause the apparatus at least to: receive, from at least one user equipment, an indication that the at least one user equipment is using at least one scheme to perform communication with the apparatus, when there is the conflict between at least one symbol of a first carrier and at least one symbol of a second carrier within a time interval; and perform the communication with the at least one user equipment with use of the at least one scheme, when there is the conflict between at least one symbol of the first carrier and at least one symbol of the second carrier within the time interval.
Example 24. The apparatus of example 23, wherein the at least one scheme comprises a puncturing of the communication over the at least one symbol of the first carrier that conflicts with the at least one symbol of the second carrier, or a puncturing of the communication over the at least one symbol of the second carrier that conflicts with the at least one symbol of the first carrier.
Example 25. The apparatus of any of examples 23 to 24, wherein the at least one scheme comprises a rate matching comprising an encoding of information of at least one symbol of the first carrier that does not conflict with at least one symbol of the second carrier, or an encoding of information of at least one symbol of the second carrier that does not conflict with at least one symbol of the first carrier.
Example 26. The apparatus of any of examples 23 to 25, wherein the at least one scheme comprises a subslot communication on at least one symbol of the first carrier that does not conflict with at least one symbol of the second carrier, or a subslot communication on at least one symbol of the second carrier that does not conflict with at least one symbol of the first carrier.
Example 27. The apparatus of any of examples 23 to 26, wherein the at least one scheme comprises carrier prioritization comprising: the communication over the at least one symbol of the first carrier that conflicts with the at least one symbol of the second carrier without the communication over the at least one symbol of the second carrier that conflicts with the at least one symbol of the first carrier, when the first carrier is associated with a higher priority than the second carrier, or the communication over the at least one symbol of the second carrier that conflicts with the at least one symbol of the first carrier without the communication over the at least one symbol of the first carrier that conflicts with the at least one symbol of the second carrier, when the second carrier is associated with a higher priority than the first carrier.
Example 28. An apparatus including: at least one processor; and at least one memory storing instructions that, when executed by the at least one processor, cause the apparatus at least to: serve a coverage area comprising at least one first user equipment and at least one second user equipment; receive a configuration from the at least one second user equipment; and transmit the configuration to the at least one first user equipment; wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment.
Example 29. The apparatus of example 28, wherein the at least one scheme comprises a puncturing of the communication over the at least one symbol of the first carrier that conflicts with the at least one symbol of the second carrier, or a puncturing of the communication over the at least one symbol of the second carrier that conflicts with the at least one symbol of the first carrier.
Example 30. The apparatus of any of examples 28 to 29, wherein the at least one scheme comprises a rate matching comprising an encoding of information of at least one symbol of the first carrier that does not conflict with at least one symbol of the second carrier, or an encoding of information of at least one symbol of the second carrier that does not conflict with at least one symbol of the first carrier.
Example 31. The apparatus of any of examples 28 to 30, wherein the at least one scheme comprises a subslot communication on at least one symbol of the first carrier that does not conflict with at least one symbol of the second carrier, or a subslot communication on at least one symbol of the second carrier that does not conflict with at least one symbol of the first carrier.
Example 32. The apparatus of any of examples 28 to 31, wherein the at least one scheme comprises carrier prioritization comprising: the communication over the at least one symbol of the first carrier that conflicts with the at least one symbol of the second carrier without the communication over the at least one symbol of the second carrier that conflicts with the at least one symbol of the first carrier, when the first carrier is associated with a higher priority than the second carrier, or the communication over the at least one symbol of the second carrier that conflicts with the at least one symbol of the first carrier without the communication over the at least one symbol of the first carrier that conflicts with the at least one symbol of the second carrier, when the second carrier is associated with a higher priority than the first carrier.
Example 33. A method including: determining whether the apparatus is expected to perform communication on a first carrier within a time interval, and communication on a second carrier within the time interval; determining whether there is a conflict between at least one symbol of the first carrier and at least one symbol of the second carrier within the time interval; determining at least one scheme to use for performing communication with at least one user equipment, when there is the conflict between the at least one symbol of the first carrier and the at least one symbol of the second carrier within the time interval; and performing the communication with the at least one user equipment using the at least one scheme.
Example 34. A method including: receiving, from at least one user equipment, an indication that the at least one user equipment is using at least one scheme to perform communication with the apparatus, when there is the conflict between at least one symbol of a first carrier and at least one symbol of a second carrier within a time interval; and performing the communication with the at least one user equipment with use of the at least one scheme, when there is the conflict between at least one symbol of the first carrier and at least one symbol of the second carrier within the time interval.
Example 35. A method including: serving a coverage area comprising at least one first user equipment and at least one second user equipment; receiving a configuration from the at least one second user equipment; and transmitting the configuration to the at least one first user equipment; wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment.
Example 36. An apparatus including: means for determining whether the apparatus is expected to perform communication on a first carrier within a time interval, and communication on a second carrier within the time interval; means for determining whether there is a conflict between at least one symbol of the first carrier and at least one symbol of the second carrier within the time interval; means for determining at least one scheme to use for performing communication with at least one user equipment, when there is the conflict between the at least one symbol of the first carrier and the at least one symbol of the second carrier within the time interval; and means for performing the communication with the at least one user equipment using the at least one scheme.
Example 37. An apparatus including: means for receiving, from at least one user equipment, an indication that the at least one user equipment is using at least one scheme to perform communication with the apparatus, when there is the conflict between at least one symbol of a first carrier and at least one symbol of a second carrier within a time interval; and means for performing the communication with the at least one user equipment with use of the at least one scheme, when there is the conflict between at least one symbol of the first carrier and at least one symbol of the second carrier within the time interval.
Example 38. An apparatus including: means for serving a coverage area comprising at least one first user equipment and at least one second user equipment; means for receiving a configuration from the at least one second user equipment; and means for transmitting the configuration to the at least one first user equipment; wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment.
Example 39. A non-transitory program storage device readable by a machine, tangibly embodying a program of instructions executable by the machine for performing operations, the operations including: determining whether the apparatus is expected to perform communication on a first carrier within a time interval, and communication on a second carrier within the time interval; determining whether there is a conflict between at least one symbol of the first carrier and at least one symbol of the second carrier within the time interval; determining at least one scheme to use for performing communication with at least one user equipment, when there is the conflict between the at least one symbol of the first carrier and the at least one symbol of the second carrier within the time interval; and performing the communication with the at least one user equipment using the at least one scheme.
Example 40. A non-transitory program storage device readable by a machine, tangibly embodying a program of instructions executable by the machine for performing operations, the operations including: receiving, from at least one user equipment, an indication that the at least one user equipment is using at least one scheme to perform communication with the apparatus, when there is the conflict between at least one symbol of a first carrier and at least one symbol of a second carrier within a time interval; and performing the communication with the at least one user equipment with use of the at least one scheme, when there is the conflict between at least one symbol of the first carrier and at least one symbol of the second carrier within the time interval.
Example 41. A non-transitory program storage device readable by a machine, tangibly embodying a program of instructions executable by the machine for performing operations, the operations including: serving a coverage area comprising at least one first user equipment and at least one second user equipment; receiving a configuration from the at least one second user equipment; and transmitting the configuration to the at least one first user equipment; wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment.
Example 42. The apparatus of example 9, wherein the configuration indicates at least one parameter of the at least one scheme.
Example 43. The apparatus of example 42, wherein the at least one parameter comprises at least one subslot symbol.
Example 44. The apparatus of example 28, wherein the at least one parameter comprises at least one subslot symbol.
Example 45. A computer readable medium comprising instructions stored thereon for performing at least the following: determining whether the apparatus is expected to perform communication on a first carrier within a time interval, and communication on a second carrier within the time interval; determining whether there is a conflict between at least one symbol of the first carrier and at least one symbol of the second carrier within the time interval; determining at least one scheme to use for performing communication with at least one user equipment, when there is the conflict between the at least one symbol of the first carrier and the at least one symbol of the second carrier within the time interval; and performing the communication with the at least one user equipment using the at least one scheme.
Example 46. A computer readable medium comprising instructions stored thereon for performing at least the following: receiving, from at least one user equipment, an indication that the at least one user equipment is using at least one scheme to perform communication with the apparatus, when there is the conflict between at least one symbol of a first carrier and at least one symbol of a second carrier within a time interval; and performing the communication with the at least one user equipment with use of the at least one scheme, when there is the conflict between at least one symbol of the first carrier and at least one symbol of the second carrier within the time interval.
Example 47. A computer readable medium comprising instructions stored thereon for performing at least the following: serving a coverage area comprising at least one first user equipment and at least one second user equipment; receiving a configuration from the at least one second user equipment; and transmitting the configuration to the at least one first user equipment; wherein the configuration indicates at least one of: a capability of the at least one second user equipment to perform within a time interval the communication on a first carrier and communication on a second carrier, that the at least one second user equipment supports at least one scheme for performing communication with at least one first user equipment, when there is the conflict between at least one symbol of the first carrier and at least one symbol of the second carrier within the time interval, or at least one parameter of the at least one scheme for performing communication with the at least one first user equipment.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):

| | |
|---|---|
| 3GPP | third generation partnership project |
| 4G | fourth generation |
| 5G | fifth generation |
| 5GC | 5G core network |
| ACK | acknowledgement |
| AGC | automatic gain control |
| AMF | access and mobility management function |
| ASIC | application-specific integrated circuit |
| CA | carrier aggregation |
| CBR | constant bit rate |
| CC | component carrier |
| CD | compact/computer disc |
| CE | control element |
| Config | configuration |
| CPU | central processing unit |
| CU | central unit or centralized unit |
| DFT-s-OFDM | discrete Fourier transform spread |
| | orthogonal frequency division multiplexing |
| DMRS | demodulation reference signal |
| DSP | digital signal processor |
| DVD | digital versatile disc |
| eNB | evolved Node B (e.g., an LTE base station) |
| EN-DC | E-UTRAN new radio-dual connectivity |
| en-gNB | node providing NR user plane and control plane |
| | protocol terminations towards the UE, and acting |
| | as a secondary node in EN-DC |
| E-UTRA | evolved universal terrestrial radio access, i.e., the |
| | LTE radio access technology |
| E-UTRAN | E-UTRA network |
| F1 | interface between the CU and the DU |
| FPGA | field-programmable gate array |
| FR1 | frequency range 1 |
| gNB | base station for 5G/NR, i.e., a node providing |
| | NR user plane and control plane protocol |
| | terminations towards the UE, and |
| | connected via the NG interface to the 5GC |
| HARQ | hybrid automatic repeat request |
| IAB | integrated access and backhaul |
| ID | identifier |
| I/F | interface |
| I/O | input/output |
| ITS | intelligent transport systems |
| IUC | inter-UE coordination |
| LMF | location management function |
| LTE | long term evolution (4G) |
| MAC | medium access control |
| MCS | modulation and coding scheme |
| MME | mobility management entity |
| MRO | mobility robustness optimization |
| NACK | negative acknowledgement |
| NCE | network control element |
| ng or NG | new generation |
| ng-eNB | new generation eNB |
| NG-RAN | new generation radio access network |
| NR | new radio |
| N/W | network |
| OFDM | orthogonal frequency division multiplexing |
| OST | one-shot transmission |
| PC5 | direct device to device communication |
| PDA | personal digital assistant |
| PDB | packet delay budget |
| PDCP | packet data convergence protocol |
| PDU | protocol data unit |
| PHY | physical layer |
| PRB | physical resource block |
| proc | process (e.g. in 3GPP TS 38.214 Tables 8.1.4-1 & 2) |
| PSBCH | physical sidelink broadcast channel |
| PSFCH | physical sidelink feedback channel |
| PSCCH | physical sidelink control channel |
| PSSCH | physical sidelink shared channel |
| RAM | random access memory |
| RAN | radio access network |
| RAN# | RAN meeting |
| RAN1 | radio layer 1 |
| RAN2 | radio layer 2 |
| RAN4 | radio performance and protocol aspects |
| Ref | reference |
| Rel | release |
| RF | radio frequency |
| RLC | radio link control |
| ROM | read-only memory |
| RP | RAN plenary (document) |
| RRC | radio resource control |
| RSRP | reference signal received power |
| RSSI | received signal strength indication |
| RU | radio unit |
| Rx, RX, rx | receiver or reception |
| SCI | sidelink control information |
| SCS | subcarrier spacing |
| SDAP | service data adaptation protocol |
| SL | sidelink |
| SL-RSRP | sidelink reference signal received power |
| SGW | serving gateway |
| SMF | session management function |
| SON | self-organizing/optimizing network |
| SPS | semi-persistent scheduling |
| S-PSS | sidelink primary synchronization signal |
| S-RSSI | sidelink received signal strength indicator |
| S-SSB | sidelink synchronization signal block |
| S-SSS | sidelink secondary synchronization signal |
| TB | transport block |
| TRP | transmission reception point |
| TS | technical specification |
| Tx, TX, tx | transmitter or transmission |
| UAV | unmanned aerial vehicle |
| UE | user equipment (e.g., a wireless, typically |
| | mobile device) |
| UPF | user plane function |
| USB | universal serial bus |
| USIM | universal subscriber identity module |
| V2X | vehicle to everything |
| X2 | network interface between RAN nodes and between |
| | RAN and the core network |
| Xn | network interface between NG-RAN nodes |

What is claimed is:

1. An apparatus comprising:
at least one processor; and
at least one memory storing instructions that, when executed by the at least one processor, cause the apparatus at least to:
determine whether the apparatus is expected to perform communication on a first carrier within a time interval, and communication on a second carrier within the time interval;
determine whether there is a conflict between at least one symbol of the first carrier and at least one symbol of the second carrier within the time interval;
determine at least one scheme to use for performing communication with at least one user equipment, when there is the conflict between the at least one symbol of the first carrier and the at least one symbol of the second carrier within the time interval; and
perform the communication with the at least one user equipment using the at least one scheme.

2. The apparatus of claim 1, wherein the instructions, when executed by the at least one processor, cause the apparatus at least to:
determine that the apparatus is expected to perform the communication on the first carrier within the time interval, and the communication on the second carrier within the time interval based on at least one of scheduling, a resource selection decision, a configured relation between transmission and feedback, or a configured resource allocation.

3. The apparatus of claim 1, wherein the instructions, when executed by the at least one processor, cause the apparatus at least to:
transmit, to the at least one user equipment, an indication that the apparatus is using the at least one scheme to perform the communication with the at least one user equipment, when there is the conflict between the at least one symbol of the first carrier and the at least one symbol of the second carrier within the time interval.

4. The apparatus of claim 1, wherein the instructions, when executed by the at least one processor, cause the apparatus at least to:
receive a configuration from the at least one user equipment or from a network;

5. The apparatus of claim 4, wherein the configuration indicates a capability of the at least one user equipment to perform within the time interval the communication on the first carrier and the communication on the second carrier.

6. The apparatus of claim 4, wherein the configuration indicates that the at least one user equipment supports the at least one scheme.

7. The apparatus of claim 4, wherein the configuration indicates at least one parameter of the at least one scheme.

8. The apparatus of claim 7, wherein the at least one parameter comprises at least one subslot symbol.

9. The apparatus of claim 1, wherein the instructions, when executed by the at least one processor, cause the apparatus at least to:
transmit a configuration to the at least one user equipment.

10. The apparatus of claim 9, wherein the configuration indicates a capability of the apparatus to perform within the time interval the communication on the first carrier and the communication on the second carrier.

11. The apparatus of claim 9, wherein the configuration indicates that the apparatus supports the at least one scheme.

12. The apparatus of claim 9, wherein the configuration indicates at least one parameter of the at least one scheme.

13. The apparatus of claim 12, wherein the at least one parameter comprises at least one subslot symbol.

14. The apparatus of claim 1, wherein the apparatus comprises another user equipment configured for carrier aggregation, and the communication with the at least one user equipment comprises transmission or reception over a channel of the first carrier and transmission or reception over a channel of the second carrier, wherein the channel of the first carrier and the channel of the second carrier comprises a physical sidelink control channel, a physical sidelink shared channel, a physical sidelink feedback channel, or a sidelink synchronization signal block.

15. The apparatus of claim 1, wherein the instructions, when executed by the at least one processor, cause the apparatus to determine the at least one scheme based on at least one of:
a capability of the apparatus,
a capability of the at least one user equipment,
a timing of a channel of the first carrier and a timing of a channel of the second carrier,
a switch time between communication over the first carrier and the second carrier,
a priority of the first carrier and a priority of the second carrier,
a target destination of the communication, the target destination comprising the apparatus or the at least one user equipment,
at least one measurement related to the at least one user equipment,
a distance between the apparatus and the at least one user equipment being lower or higher than a threshold,
a network configuration, or
a configuration of the apparatus.

16. The apparatus of claim 1, wherein the at least one scheme comprises a puncturing of the communication over the at least one symbol of the first carrier that conflicts with the at least one symbol of the second carrier, or a puncturing of the communication over the at least one symbol of the second carrier that conflicts with the at least one symbol of the first carrier.

17. The apparatus of claim 16, wherein the at least one scheme comprises the puncturing of the communication when the at least one user equipment comprises a legacy user equipment.

18. The apparatus of claim 16, wherein the at least one scheme comprises the puncturing of the communication when the apparatus determines to communicate over a physical sidelink feedback channel of one of the first carrier or the second carrier after a communication over a physical sidelink shared channel of another one of the first carrier or the second carrier has started.

19. The apparatus of claim 1, wherein the at least one scheme comprises a rate matching comprising an encoding of information of at least one symbol of the first carrier that does not conflict with at least one symbol of the second carrier, or an encoding of information of at least one symbol of the second carrier that does not conflict with at least one symbol of the first carrier.

20. The apparatus of claim 19, wherein the at least one scheme comprises the rate matching when the conflict between the at least one symbol of the first carrier and the at least one symbol of the second carrier does not overlap with a physical sidelink control channel.

21. The apparatus of claim 1, wherein the at least one scheme comprises a subslot communication on at least one symbol of the first carrier that does not conflict with at least one symbol of the second carrier, or a subslot communication on at least one symbol of the second carrier that does not conflict with at least one symbol of the first carrier.

22. The apparatus of claim 21, wherein the at least one scheme comprises the subslot communication when the conflict between the at least one symbol of the first carrier and the at least one symbol of the second carrier overlaps with a physical sidelink control channel.

23. The apparatus of claim 1, wherein the at least one scheme comprises carrier prioritization comprising:
the communication over the at least one symbol of the first carrier that conflicts with the at least one symbol of the second carrier without the communication over the at least one symbol of the second carrier that conflicts with the at least one symbol of the first carrier, when a priority associated with the first carrier is higher than a priority associated with the second carrier, or
the communication over the at least one symbol of the second carrier that conflicts with the at least one symbol of the first carrier without the communication over the at least one symbol of the first carrier that conflicts with the at least one symbol of the second carrier, when the priority associated with the second carrier is higher than the priority associated with the first carrier.

24. The apparatus of claim 23, wherein the priority associated with the first carrier and the priority associated with the second carrier is based on at least one of:
a physical sidelink feedback channel priority,
a physical sidelink control channel priority,
a physical sidelink shared channel priority,
a sidelink synchronization signal block priority,
a communication time associated with the first carrier and a communication time associated with the second carrier, or
a priority of the first carrier and a priority of the second carrier.

25. An apparatus comprising:
at least one processor; and
at least one memory storing instructions that, when executed by the at least one processor, cause the apparatus at least to:
receive, from at least one user equipment, an indication that the at least one user equipment is using at least one scheme to perform communication with the apparatus, when there is the conflict between at least one symbol of a first carrier and at least one symbol of a second carrier within a time interval; and
perform the communication with the at least one user equipment with use of the at least one scheme, when there is the conflict between at least one symbol of the first carrier and at least one symbol of the second carrier within the time interval.

26. The apparatus of claim 25, wherein the at least one scheme comprises a puncturing of the communication over the at least one symbol of the first carrier that conflicts with the at least one symbol of the second carrier, or a puncturing of the communication over the at least one symbol of the second carrier that conflicts with the at least one symbol of the first carrier.

27. The apparatus of claim 25, wherein the at least one scheme comprises a rate matching comprising an encoding of information of at least one symbol of the first carrier that does not conflict with at least one symbol of the second carrier, or an encoding of information of at least one symbol of the second carrier that does not conflict with at least one symbol of the first carrier.

28. The apparatus of claim 25, wherein the at least one scheme comprises a subslot communication on at least one symbol of the first carrier that does not conflict with at least one symbol of the second carrier, or a subslot communication on at least one symbol of the second carrier that does not conflict with at least one symbol of the first carrier.

29. The apparatus of claim 25, wherein the at least one scheme comprises carrier prioritization comprising:
the communication over the at least one symbol of the first carrier that conflicts with the at least one symbol of the second carrier without the communication over the at least one symbol of the second carrier that conflicts with the at least one symbol of the first carrier, when the first carrier is associated with a higher priority than the second carrier, or
the communication over the at least one symbol of the second carrier that conflicts with the at least one symbol of the first carrier without the communication over the at least one symbol of the first carrier that conflicts with the at least one symbol of the second carrier, when the second carrier is associated with a higher priority than the first carrier.

30. An apparatus comprising:
at least one processor; and
at least one memory storing instructions that, when executed by the at least one processor, cause the apparatus at least to:
serve a coverage area comprising at least one first user equipment and at least one second user equipment;
receive a configuration from the at least one second user equipment; and
transmit the configuration to the at least one first user equipment;
wherein the configuration indicates at least one of:
a capability of the at least one second user equipment to perform within a time interval the communication on a first carrier and communication on a second carrier,
that the at least one second user equipment supports at least one scheme for performing communication with at least one first user equipment, when there is the conflict between at least one symbol of the first carrier and at least one symbol of the second carrier within the time interval, or
at least one parameter of the at least one scheme for performing communication with the at least one first user equipment.

31. The apparatus of claim 30, wherein the at least one scheme comprises a puncturing of the communication over the at least one symbol of the first carrier that conflicts with the at least one symbol of the second carrier, or a puncturing of the communication over the at least one symbol of the second carrier that conflicts with the at least one symbol of the first carrier.

32. The apparatus of claim 30, wherein the at least one scheme comprises a rate matching comprising an encoding of information of at least one symbol of the first carrier that does not conflict with at least one symbol of the second carrier, or an encoding of information of at least one symbol of the second carrier that does not conflict with at least one symbol of the first carrier.

33. The apparatus of claim 30, wherein the at least one scheme comprises a subslot communication on at least one symbol of the first carrier that does not conflict with at least one symbol of the second carrier, or a subslot communication on at least one symbol of the second carrier that does not conflict with at least one symbol of the first carrier.

34. The apparatus of claim 30, wherein the at least one scheme comprises carrier prioritization comprising:
the communication over the at least one symbol of the first carrier that conflicts with the at least one symbol of the second carrier without the communication over the at least one symbol of the second carrier that conflicts with the at least one symbol of the first carrier, when the first carrier is associated with a higher priority than the second carrier, or
the communication over the at least one symbol of the second carrier that conflicts with the at least one symbol of the first carrier without the communication over the at least one symbol of the first carrier that conflicts with the at least one symbol of the second carrier, when the second carrier is associated with a higher priority than the first carrier.

35. The apparatus of claim 30, wherein the at least one parameter comprises at least one subslot symbol.
